(19) United States
(12) Patent Application Publication
(10) Pub. No.: US 2026/0346185 A1
(43) Pub. Date: Nov. 5, 2026

(54) PROCESS FOR ABSORBING CARBON DIOXIDE FROM FLUE GAS AND MINERALIZING IT USING ALKALINE INDUSTRIAL WASTES

(71) Applicant: Wisconsin Alumni Research Foundation, Madison, WI (US)

(72) Inventors: Bu Wang, Verona, WI (US); Raghavendra Ragipani, Kanpur (IN)

(73) Assignee: Wisconsin Alumni Research Foundation, Madison, WI (US)

(21) Appl. No.: 19/197,060

(22) Filed: May 2, 2025

(51) Int. Cl. B01D 53/14; B01D 53/62; B01D 53/75; B01D 53/78

(52) U.S. Cl. CPC B01D 53/1475; B01D 53/1406; B01D 53/1493; B01D 53/62; B01D 53/75; B01D 53/78; B01D 2251/304; B01D 2251/604; B01D 2252/30; B01D 2257/504

(57) ABSTRACT

A method of sequestering gaseous carbon dioxide (CO₂), comprising carbonating a solid feedstock comprising an oxide or a hydroxide with a first aqueous carbonate solution to yield carbonate precipitates and an aqueous hydroxide solution. A CO₂-containing gas stream is first contacted with an aqueous alkaline solution for a time and under conditions wherein at least a portion of CO₂ in the gas stream is sequestered into a second aqueous carbonate solution. A water-soluble zwitterion catalyst may be added to the aqueous alkaline solution to enhance CO₂ absorption. The resulting gas stream is subsequently contacted with the aqueous hydroxide solution formed from carbonation of the solid feedstock for a time and under conditions wherein at least a portion of CO₂ in the gas stream is sequestered into a third aqueous carbonate solution.

### BACKGROUND

Estimates suggest that heavy industries such as cement, steel, chemicals, and coal-fired power plants together contribute about 70% of total carbon dioxide emissions, worldwide. To address global warming concerns, carbon dioxide capture, utilization, and storage is considered critical.

The scientific and patent literature regarding carbon dioxide capture and sequestration is extensive and covers several distinct approaches. For example, U.S. Pat. No. 5,100,633, issued Mar. 31, 1992, to Morrison, describes a process for scrubbing acid-forming gases, including sulfur dioxide and carbon dioxide, from flue gases. The untreated flue gas is first passed through a heat exchanger and then reacted with an aqueous, alkaline scrubbing solution. After the reaction, the solution, now containing dissolved salts with a precipitate of any insolubles, is passed through another heat exchanger to evaporate the water. These leaves a solid residue of crystallized, carbon-containing salts.

Grander schemes have included fundamentally altering the carbon balance of the planet by increasing the alkalinity of the oceans. See H. Kheshgi (1995) “Sequestering Atmospheric Carbon Dioxide by Increasing Ocean Alkalinity,” Energy, 20 (9): 912-922. Here, the author proposes adding calcium oxide to the oceans in sufficient quantity to increase the carbon dioxide-absorbing capacity of the oceans. Clearly such a far-reaching “solution” is not feasible.

Chemical reactions of gaseous carbon dioxide, water, and carbonate minerals have been extensively studied. For a thorough review, see Morse and Mackenzie, “Geochemistry of Sedimentary Carbonates” ISBN 978-0444873910, © 1990, Elsevier Science (Amsterdam, Netherlands). These studies, though, are in the context of sedimentology, rather than carbon dioxide capture.

There remains a long-felt and unmet need for an economically feasible, scientifically feasible, and effective method for capturing and sequestering man-made carbon dioxide.

### SUMMARY

Disclosed herein is a process for absorption-based carbon dioxide capture, where the CO₂-rich solvent is regenerated by reaction with alkaline industrial wastes at atmospheric conditions without a need for heat input.

Heavy industries such as cement, steel, chemical manufacturing, and power plants are heavy emitters of carbon dioxide. Current CO₂ capture solutions are expensive due to high energy requirements for solvent or sorbent regeneration. The present disclosure relates to solvent regeneration by reaction using alkaline residues typically available in heavy industries, such as various slags, coal fly ash, bottom ash, incinerator ash, waste cement or natural minerals. The process described herein can effectively capture carbon dioxide from any carbon dioxide containing streams, such as flue gas, vent gases, or directly from air. Moreover, the process has a wide operating window, utilizes various industrial wastes and natural minerals, and overcomes critical concerns related to scale formation.

Specifically, disclosed and claimed herein is a method of sequestering gaseous carbon dioxide (CO₂), the method comprising:
(a) contacting a solid feedstock comprising an oxide or a hydroxide with a first aqueous carbonate solution for a time and under conditions wherein:
   (i) at least a portion of the oxide or hydroxide in the feedstock is converted into a carbonate and wherein at least a portion of the carbonate so formed precipitates from the aqueous carbonate solution, to yield a precipitate; and
   (ii) an aqueous hydroxide solution is formed;
(b) contacting a CO₂-containing gas stream with an aqueous alkaline solution for a time and under conditions wherein at least a portion of CO₂ in the CO₂-containing gas stream is sequestered into a second aqueous carbonate solution, thereby creating a treated gas stream; and
(c) contacting the treated gas stream exiting step (b) with the aqueous hydroxide solution formed in step (a)(ii) for a time and under conditions wherein at least a portion of CO₂ in the treated gas stream exiting step (b) is sequestered into a third aqueous carbonate solution.

The solid feedstock suitable for use comprises alkaline solid waste. The alkaline solid waste may be selected from the group consisting of slag, fly ash, bottom ash, incinerator ash, waste cement, and natural minerals.

In certain versions, the first aqueous carbonate solution of step (a) comprises one or more water-soluble carbonates selected from the group consisting of sodium carbonate, potassium carbonate, sodium bicarbonate, and potassium bicarbonate. Preferably, the first aqueous carbonate solution comprises alkali bicarbonates and has a pH ranging from about 6.0 to 12.0. More preferably, the pH of the first aqueous carbonate solution is less than 8.0.

In step (a), the first aqueous carbonate solution flows in a countercurrent or crosscurrent direction relative to the feedstock, continuously or semi-continuously, with a residence time ranging from about 1 second to about 24 hours. This flow pattern enhances carbonation efficiency and improves the pH of the resulting aqueous hydroxide solution.

The method can be used for sequestering CO₂ in any CO₂-containing gas stream. In certain versions, the CO₂-containing gas stream is selected from the group consisting of flue gas, vent gas, and air.

The aqueous alkaline solution in step (b) comprises one or more alkaline components selected from the group consisting of hydroxides, carbonates, and bicarbonates. Preferably, the aqueous alkaline solution in step (b) has a pH of about 9.5 or higher.

In certain versions, the method further comprises adding a water-soluble zwitterion to the aqueous alkaline solution in step (b) prior to contacting the solution with the CO2-containing gas stream. Preferably, the zwitterion is an amino acid, such as glycine. The water-solution zwitterion catalyst, when loaded with the aqueous alkaline solution, enhances carbon dioxide absorption.

In certain versions, the method further comprises using at least a portion of the third aqueous carbonate solution formed in step (c) as at least a portion of the aqueous alkaline solution of step (b).

In certain versions, the method further comprises adding a mineral acid to the third aqueous carbonate solution formed in step (c), wherein at least a portion of calcium, magnesium, silica, alumina, and sulfates present in the third aqueous carbonate solution is precipitated to yield a precipitate and an acid treated solution. In this particular version, the method further comprises using at least a portion of the acid treated solution as at least a portion of the aqueous alkaline solution of step (b). The method may also comprise mixing a portion of the second aqueous carbonate solution formed in step (b) with the mineral acid and the third aqueous carbonate solution formed in step (c). Preferably, the acid treated solution has a pH of 9.5 or higher.

In certain versions, the method further comprises using at least a portion of the second aqueous carbonate solution formed in step (b) as at least a portion of the first aqueous carbonate solution in step (a).

The method may further comprise cooling the CO₂-containing gas stream using water prior to contacting it with the aqueous alkaline solution in step (b), wherein at least a portion of the water generated during the cooling is reused in preparing at least a portion of the first aqueous carbonate solution in step (a).

The objects and advantages of the disclosure will appear more fully from the following detailed description of the preferred embodiment of the disclosure made in conjunction with the accompanying drawings.

### BRIEF DESCRIPTION OF THE DRAWINGS

The sole drawing FIGURE is a schema of an exemplary workflow of the method disclosed herein. Liquid-phase streams are represented by solid lines; solid-phase streams by dotted lines; gas-phase streams by dashed lines; and mixed solid-liquid streams by long dashed lines.

### DETAILED DESCRIPTION

### Definitions

As used herein, the singular forms “a,” “an,” and “the” include plural referents unless the content clearly dictates otherwise.

As used herein, the term “or” is an inclusive “or” operator and is equivalent to the term “and/or” unless the context clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

The elements and method steps described herein can be used in any combination whether explicitly described or not.

All combinations of method steps as used herein can be performed in any order, unless otherwise specified or clearly implied to the contrary by the context in which the referenced combination is made.

The method disclosed herein can comprise, consist essentially of, or consist of the essential elements and steps described herein, as well as any additional or optional ingredients, components, or limitations described herein or otherwise useful in the art. The disclosure provided herein suitably may be practiced in the absence of any element which is not specifically disclosed herein.

It is understood that the disclosure is not confined to the particular ingredients, compositions of matter, or steps herein illustrated and described, but embraces such modified forms thereof as come within the scope of the claims.

The “mineral feedstock” or “solid feedstock” as used herein can comprise any composition comprising at least some mineral component. The mineral component may include, but is not limited to, silicates, oxides, sulfates, sulfides, carbonates, native elements, and halides, or any combination thereof. In various embodiments, the mineral component may comprise silicon-containing minerals, such as silicates, silicate hydrates, silicon oxides, and aluminosilicates; aluminum-containing minerals, such as aluminum oxides, aluminosilicates, hydroxyaluminates, aluminates, and mixed oxides containing aluminum; calcium-containing minerals, such as calcium silicate, calcium aluminosilicate, and calcium aluminates; and magnesium-containing minerals or calcium-magnesium mixed minerals, such as ground olivine, basalt, and serpentine. The mineral feedstock may comprise industrial mineral waste. As used herein, “industrial mineral waste” refers to any waste or byproducts of the processing of mineral-containing materials. Exemplary processes include mining, ore refining, mineral refining, fossil fuel refining, and fossil fuel combustion, among others. Industrial mineral waste may include, but is not limited to, alkaline solid waste, and examples include waste rock, mill tailings, coal refuse, wash slimes, spent oil shale, coal ash (e.g., fresh coal ash, reclaimed coal ash, off-spec coal ash, fly ash, and bottom ash), slag (e.g., blast furnace slag, iron slag, steel slag, basic oxygen furnace slag, electric arc furnace slag, and boiler slag), cement kiln dust, ground glass, and recycled concrete, among others.

The “CO₂-containing gas stream,” used interchangeably with “gas stream comprising CO₂” or “CO₂-rich gas stream,” refers to a gas stream containing carbon dioxide in any proportion, optionally mixed with one or more other gases, and at any pressure. The gas stream may be at atmospheric pressure or above, with atmospheric or elevated pressures being preferred. In some versions, the CO₂-containing gas stream is ambient air. In some versions, it comprises a more concentrated source of CO₂, such as flue gas from an industrial process.

Unless explicitly specified to the contrary, the term “solution” is used herein to refer to an aqueous solution, wherein “aqueous” refers to containing water as a solvent or medium. In any solution herein, the solution preferably comprises water in an amount of at least 50% v/v, such as at least 55% v/v, at least 60% v/v, at least 65% v/v, at least 70% v/v, at least 75% v/v, at least 80% v/v, at least 85% v/v, at least 90% v/v, at least 95% v/v, or at least 99% v/v. For the avoidance of doubt, such volumes of the solutions account for only the volumes of the liquid portions of the solutions (including any molecules dissolved therein) and do not account for the volumes of any solids contacted, suspended, or dispersed therein.

As used herein, the term “aqueous carbonate solution” or “carbonate solution” refers to an aqueous solution comprising one or more carbonate salts. Any carbonate that is sparingly soluble to very soluble in water may be used. Exemplary carbonates include, but are not limited to, sodium carbonate (Na₂CO₃), potassium carbonate (K₂CO₃), sodium bicarbonate (NaHCO₃), and potassium bicarbonate (KHCO₃). The carbonate solution may optionally include hydroxide ions (OH⁻) to adjust or maintain a higher pH.

As used herein, the term “aqueous hydroxide solution” or “hydroxide solution” refers to an aqueous solution comprising one or more hydroxide compounds. Any hydroxide that is sparingly soluble to very soluble in water may be used. Exemplary hydroxides include, but are not limited to, sodium hydroxide (NaOH), potassium hydroxide (KOH), lithium hydroxide (LiOH), rubidium hydroxide (RbOH), cesium hydroxide (CsOH), calcium hydroxide (Ca(OH)₂), strontium hydroxide (Sr(OH)₂), and barium hydroxide (Ba(OH)₂). Preferred hydroxides include alkali hydroxides, which include sodium hydroxide (NaOH), potassium hydroxide (KOH), lithium hydroxide (LiOH), rubidium hydroxide (RbOH), and cesium hydroxide (CsOH).

As used herein, the term “aqueous alkaline solution” or “alkaline solution” refers to an aqueous solution comprising one or more alkaline components. Such components may include hydroxides (e.g., NaOH, KOH), carbonates (e.g., Na₂CO₃, K₂CO₃), bicarbonates (e.g., NaHCO₃, KHCO₃), or combinations thereof.

As used herein, a “zwitterion” refers to a molecule that contains both a positively charged group and a negatively charged group within the same molecule, resulting in an overall neutral charge. In one version, the zwitterion is an amino acid. The term “amino acid” as used herein refers to a molecule containing both an amino group (—NH₂) and a carboxylic acid group (—COOH). Amino acids may be naturally occurring or synthetic, and can include standard proteinogenic amino acids (e.g., lysine, glycine), non-proteinogenic amino acids (e.g., β-alanine, γ-aminobutyric acid), modified amino acids (e.g., phosphorylated, acetylated, or methylated derivatives), and amino acid analogs or derivatives, which retain the structural features of an amino acid but may have substitutions, modifications, or alternative functional groups. Amino acids may exhibit chirality, existing as D- or Lenantiomers, or as racemic mixtures. The pKa range of amino acids typically spans 2.0-2.5 for the carboxylic acid group and 9.0-10.5 for the amino group, with variations depending on the side chain structure.

### Process for CO₂ Absorbing and Mineralization

Disclosed herein is a process for absorption-based carbon dioxide capture, where the CO₂-rich solvent is regenerated by reaction with alkaline industrial wastes at atmospheric conditions without a need for heat input. This process offers a wider operating window, utilizes various industrial wastes and natural minerals, and overcomes critical concerns related to scale formation.

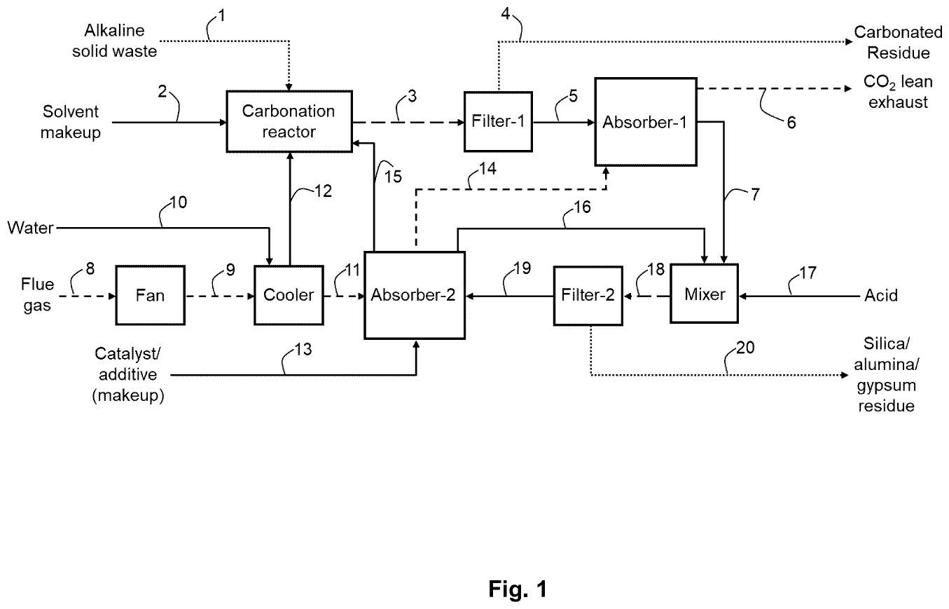

FIG. 1 shows an exemplary CO₂ capture and sequestration process as disclosed herein. As shown in the figure, the process comprises a carbonation reactor that receives a solid feedstock (e.g., an alkaline solid waste; stream no. 1) and a solvent makeup (stream no. 2). The solvent makeup is an aqueous carbonate solution that reacts with the calcium (Ca) and magnesium (Mg) containing minerals in the feedstock, leading to the formation of insoluble metal carbonates (stream no. 4), such as calcium carbonate (CaCO₃) and magnesium carbonate (MgCO₃), along with the generation of a hydroxide solution (stream no. 5). This hydroxide solution is then used in Absorber-1 to absorb CO₂, producing a CO₂ lean exhaust (stream no. 6) and regenerating a carbonate solution (stream no. 7). Exemplary underlying chemical reactions in the carbonation reactor and Absorber-1 are:

2CaO▪SiO₂+2Na₂CO₃+2H₂O→2CaCO₃↓+SiO₂+4NaOH CO₂+4NaOH→2Na₂CO₃+2H₂O

In the reactions, carbonation of calcium oxides, silicates, and aluminates using sodium carbonate solutions increases the pH of the aqueous reaction solution due to the generation of soluble sodium hydroxide. Absorption of carbon dioxide from gas streams into the sodium hydroxide solution is efficient and regenerates sodium carbonates.

The carbonation reaction may be conducted under atmospheric conditions without the need for heat input. However, temperatures, pressures, and other conditions deviating from atmospheric conditions also fall within the scope of the method.

In certain versions, the carbonate solution (stream no. 2) fed into the carbonation reactor has a pH range of 6.0-12.0, preferably less than 8.0. The carbonate solution may comprise alkali bicarbonates. Alkaline residue (stream no. 1) is fed to the carbonation reactor to precipitate calcium carbonate and regenerate hydroxide solvent.

In certain versions, in the carbonation reactor, there is countercurrent or crosscurrent solvent flow vis-à-vis solids movement, either continuously or semi-continuously, with a residence time of 1 second to 24 hours. This flow pattern enhances carbonation efficiency and improves the pH of Absorber-1 solvent (stream no. 5).

In certain versions, the pH of the hydroxide solution entering Absorber-1 (stream no. 5) is greater than about 13. Preferably, Absorber-1 operates in the pH range of 8.0 14.0, such that solvent stream no. 5 is fed at a maximum pH of 14.0 and solvent outlet stream no. 7 is drawn at a pH of 8.0. More preferably, Absorber-1 operates in the pH range of 10.3-14.0, such that solvent stream no. 5 is fed at a maximum pH of 14.0 and solvent outlet stream no. 7 is drawn at a pH of 10.3. Even more preferably, solvent outlet stream no. 7 is drawn at a pH of 10.5 or higher, which helps to prevent silica fouling on packings.

Before entering Absorber-1 for CO₂ absorption, the CO₂-rich gas (e.g., a flue gas, stream no. 8) is first treated in Absorber-2 using an aqueous alkaline solution (stream no. 19). The alkaline solution comprises one or more alkaline components, such as hydroxides, carbonates, and/or bicarbonates.

Preferably, a water-soluble zwitterion catalyst is added as makeup (stream no. 13) to Absorber-2. The zwitterion suitable for use is not limited. Typically, it comprises an acidic group with a low pKa value from about 1.0 to about 4.0, and a basic group with a relatively high pKa from 6.0 to 13.0. The zwitterion may be selected from amino acids (e.g., glycine), betaines (e.g., trimethylglycine), or other water-soluble zwitterionic compounds capable of enhancing CO₂ absorption. In preferred versions, the zwitterion is an amino acid. More preferably, the zwitterion is glycine. The zwitterion catalyst may be added at a concentration ranging from 0 to 250 g/L. In certain versions, the aqueous alkaline solution, when loaded with catalyst such as glycine, enhances carbon dioxide absorption and rapidly reduces the solvent outlet (stream no. 15 and 16) pH to as low as 8.0. This enhances the CO₂ capture capacity of solvent and mineral carbonation efficiency per cycle. The gas outlet from Absorber-2 (stream no. 14) is directed to Absorber-1 for additional CO₂ absorption.

In certain versions, Absorber-2 is operated in the pH range of 8.0-10.5, such that solvent stream no. 19 is fed at a pH of 10.5 and solvent outlet stream no. 15 and 16 are drawn at a pH of 8.0. Preferably, Absorber-2 is operated in the pH range of 8.0-10.0. In certain embodiments, Absorber-2 is operated in the pH range of 8.0-9.5, such that solvent stream no. 19 is fed at a pH of 9.5 and solvent outlet stream no. 15 and 16 are drawn at a pH of 8.0. In certain embodiments, solvent outlet stream no. 15 and 16 are drawn at a pH less than 8.0.

To reduce overall solvent costs, the carbonate solution produced from Absorber-1 (stream no. 7) is reused as the solvent for CO₂ absorption in Absorber-2. Prior to use, the solvent stream (no. 7) drawn out of Absorber-1 is mixed with a mineral acid (e.g., H₂SO₄, stream no. 17) and/or a part of the solvent outlet stream (no. 16) from Absorber-2, which forms sparingly soluble precipitate with calcium and magnesium ions. Preferably, this process is carried out in the pH range of 10.5-9.5, such that pH of the solution after acid mixing (stream no. 19) is about 9.5. More preferably, the pH is no less than 9.0. The precipitate (stream no. 20) containing other insoluble components is separated from the solution using a filter. These precipitates include silica, alumina, carbonates and sulfates of alkali earth metals. Removal of these precipitates from the solvent reduces scale formation in Absorber-2 unit.

In certain versions, the solvent (stream no. 15) drawn out from Absorber-2 unit, containing carbonates formed during CO₂ absorption, is directed to the carbonation reactor for reuse.

For gas streams at elevated temperatures, such as flue gas from an industrial process, the stream may optionally be cooled using a fan and/or a heat exchanger (e.g., water-based) to reduce its temperature before it is directed to Absorber-2. In the exemplary process shown in FIG. 1, flue gas from the stack (stream no. 8), which is rich in carbon dioxide, is sent to a spray tower (stream no. 9) wherein gas temperature is reduced to 20-100 °C using water (stream no. 10). Cooled flue gas (stream no. 11) is sent to Absorber-2 where it is contacted with the CO₂-capturing solvent. A part of hot water generated from the spray tower is either directly sent to the carbonation reactor (stream no. 12) or first sent to wash filter cakes and then the wash water is sent to the carbonation reactor.

In sum, key steps of the process disclosed herein include: (1) use of two absorber units instead of single unit for CO₂ absorption; (2) use of zwitterionic amino acid additives to the second absorber column to enhance kinetics; (3) separation of scale-forming products (precipitated silica, alumina, calcium carbonates etc. by acid dosing, and (4) use of counter-current or cross-current solid-liquid flow in the carbonation reactor for better carbonation kinetics and CO₂ storage.

The process disclosed herein considers the role of pH and scale formation. The process has a wider operating pH window. Thus, most alkaline industrial waste and natural minerals can be rapidly carbonated. This process systematically separates scale forming precipitates and lowers plant downtime and maintenance costs.

This process innovation provides cost-effective technology for CO₂ capture from heavy industries, especially those producing waste alkaline residues. This technology eliminates solvent regeneration by energy intensive methods such as temperature swing, pressure-swing, vacuum-pressure swing, which make the CO₂ capture expensive. This technology also provides a low-cost direct carbon dioxide sequestration without the need for expensive CO₂ purification and compression steps. The carbonated residues may be used in construction industry and for soil conditioning.

What is claimed is:

1. A method of sequestering gaseous carbon dioxide (CO₂), the method comprising:
(a) contacting a solid feedstock comprising an oxide or a hydroxide with a first aqueous carbonate solution for a time and under conditions wherein:
(i) at least a portion of the oxide or hydroxide in the feedstock is converted into a carbonate and wherein at least a portion of the carbonate so formed precipitates from the aqueous carbonate solution, to yield a precipitate; and
(ii) an aqueous hydroxide solution is formed;
(b) contacting a CO₂-containing gas stream with an aqueous alkaline solution for a time and under conditions wherein at least a portion of CO₂ in the CO₂-containing gas stream is sequestered into a second aqueous carbonate solution, thereby creating a treated gas stream; and
(c) contacting the treated gas stream exiting step (b) with the aqueous hydroxide solution formed in step (a)(ii) for a time and under conditions wherein at least a portion of CO₂ in the treated gas stream exiting step (b) is sequestered into a third aqueous carbonate solution.

2. The method of claim 1, wherein the solid feedstock in step (a) comprises alkaline solid waste.

3. The method of claim 2, wherein the alkaline solid waste is selected from the group consisting of slag, fly ash, bottom ash, incinerator ash, waste cement, and natural minerals.

4. The method of claim 1, wherein the first aqueous carbonate solution comprises one or more water-soluble carbonates selected from the group consisting of sodium carbonate, potassium carbonate, sodium bicarbonate, and potassium bicarbonate.

5. The method of claim 1, wherein the first aqueous carbonate solution comprises alkali bicarbonates and has a pH ranging from about 6.0 to 12.0.

6. The method of claim 5, wherein the pH of the first aqueous carbonate solution is less than 8.0.

7. The method of claim 1, wherein in step (a), the first aqueous carbonate solution flows in a countercurrent or crosscurrent direction relative to the feedstock, continuously or semi-continuously, with a residence time ranging from about 1 second to about 24 hours.

8. The method of claim 1, wherein the CO₂-containing gas stream is selected from the group consisting of flue gas, vent gas, and air.

9. The method of claim 1, wherein the aqueous alkaline solution in step (b) comprises one or more alkaline components selected from the group consisting of hydroxides, carbonates, and bicarbonates.

10. The method of claim 9, wherein the aqueous alkaline solution in step (b) has a pH of about 9.5 or higher.

11. The method of claim 1, further comprising adding a water-soluble zwitterion to the aqueous alkaline solution in step (b) prior to contacting the solution with the CO₂-containing gas stream.

12. The method of claim 10, wherein the zwitterion is an amino acid.

13. The method of claim 1, further comprising using at least a portion of the third aqueous carbonate solution formed in step (c) as at least a portion of the aqueous alkaline solution of step (b).

14. The method of claim 13, further comprising adding a mineral acid to the third aqueous carbonate solution formed in step (c), wherein at least a portion of calcium, magnesium, silica, alumina, and sulfate present in the third aqueous carbonate solution is precipitated to yield a precipitate and an acid-treated solution.

15. The method of claim 14, further comprising using at least a portion of the acid-treated solution as at least a portion of the aqueous alkaline solution of step (b).

16. The method of claim 14, further comprising mixing a portion of the second aqueous carbonate solution formed in step (b) with the mineral acid and the third aqueous carbonate solution formed in step (c).

17. The method of claim 14, wherein the acid treated solution has a pH of 9.5 or higher.

18. The method of claim 1, further comprising using at least a portion of the second aqueous carbonate solution formed in step (b) as at least a portion of the first aqueous carbonate solution in step (a).

19. The method of claim 1, further comprising cooling the CO₂-containing gas stream using water prior to contacting it with the aqueous alkaline solution in step (b), wherein at least a portion of the water generated during the cooling is reused in preparing at least a portion of the first aqueous carbonate solution in step (a).
